(19) United States
(12) Patent Application Publication
(10) Pub. No.: US 2003/0032426 A1
(43) Pub. Date: Feb. 13, 2003

(54) Aircraft data and voice communications system and method

(76) Inventors: Jon S. Gilbert, LaJolla, CA (US); Scott Boden, LaJolla, CA (US); Roger F. Atkinson, El Cajon, CA (US)

Correspondence Address: EPSTEIN, EDELL, SHAPIRO, FINNAN & LYTLE, LLC, Suite 400, 1901 Research Boulevard, Rockville, MD, 20850-3164, US

(21) Appl. No.: 10/201,576

(22) Filed: Jul. 24, 2002

Related U.S. Application Data
(60) Provisional application No. 60/307,146, filed on Jul. 24, 2001.

(51) Int. Cl. H04Q 7/20

(52) U.S. Cl. 455/427; 455/428; 455/430

(57) ABSTRACT

Satellite and terrestrial voice and data communications are included within a communications server system, preferably for an aircraft. The system collects and logs data concerning the aircraft and flight via various sensors. The data may be delivered to a ground facility in real time via a packet data satellite link. Alternatively, the data may be cached and transmitted in bursts via a circuit or short burst message network, or transmitted after an aircraft has landed via a terrestrial or satellite data link. The system includes connections for computers and enables access to databases on the ground and to electronic mail and the Internet. A GPS receiver is included in the system for recording the aircraft location, while approximate altitude information is available using differential GPS. The system includes a satellite voice terminal to facilitate voice communications and interfaces to headsets and to ordinary telephones.

### CROSS-REFERENCE TO RELATED APPLICATIONS

This application claims priority to U.S. Provisional Patent Application Ser. No. 60/307,146, entitled “Integrated Airborne Data and Voice Communications Unit” and filed Jul. 24, 2001, the disclosure of which is incorporated herein by reference in its entirety.

### BACKGROUND OF THE INVENTION

1. Technical Field

The present invention pertains to communications systems. In particular, the present invention pertains to a voice and data communications system that establishes voice and data communications for aircraft (e.g., airborne or on the ground) via satellite links. In addition, the communications system may alternatively establish the voice and data communications for aircraft on the ground via terrestrial cellular links.

2. Discussion of Related Art

Current aircraft radio communications are implemented by an ad hoc collection of diverse communications systems, a majority of which are analog. These systems are each directed toward a particular purpose with varying requirements for compatibility with legacy infrastructure. Further, individual systems are becoming available to provide various features, such as downloading weather information to the aircraft and facilitating telephone calls (e.g., for transferring voice and data). Moreover, current aircraft telephone systems employ a terrestrial infrastructure to provide telephone service commonly expected by users on the aircraft. In addition, aircraft typically include a flight recorder system to log various information about the aircraft and flight. A system recorder and storage unit are heavily protected from severe conditions encountered by a downed aircraft to enable retrieval of the stored information.

The above-described systems suffer from several disadvantages. In particular, the diverse communications systems are limited to certain applications and cannot be expanded to perform additional tasks due to safety and regulatory issues. The weather and telephone call systems are similarly limited to specific applications. Further, weight, space and power consumption are important considerations for aircraft, especially with respect to the new generation of very light aircraft being designed. Since aircraft employ independent communications systems with no provisions for integrating the features into a single unit with a single antenna installation, the quantity of airframe equipment required is substantially increased, thereby reducing aircraft payload and utilizing the limited aircraft space and power resources. Moreover, the individual antennas required for the individual communications systems protrude from the airframe, causing drag, and are each heavy and employ heavy cable, thereby reducing aircraft performance. In addition, the mounting of each of those antennas is expensive and substantially increases system costs. The current aircraft telephone systems utilize a terrestrial infrastructure that incurs high costs and limited coverage, typically restricted to a single continent or country. Thus, worldwide telephone service may require several different expensive and heavy radio installations on the aircraft for different parts of the world, thereby affecting aircraft payload, performance and power consumption as described above. The flight recorder systems require the recording and storage units to be protected, thereby increasing the complexity, materials and costs of adequately protecting that system in the event of a downed aircraft.

In addition, the above described communications systems fail to address or provide various applications for the aircraft. For example, the systems do not provide automatic aircraft position reporting and telemetry of airframe and engine data and do not enable ground personnel to remotely monitor (e.g., via audio, still pictures, video telemetry, etc.) unusual activities on the aircraft affecting the safety of the crew and passengers (e.g., especially with respect to larger aircraft). With respect to corporate and air taxi applications, there is no manner for the systems to provide current (e.g., up to date) flight progress information that is vital for efficient flight dispatch and customer satisfaction. Further, the systems do not provide remote telemetry on which some small jet aircrafts depend to lower operating costs by alerting ground personnel of aircraft performance issues in order to promptly resolve the problem before the problem becomes expensive or delays flight operations.

### OBJECTS AND SUMMARY OF THE INVENTION

Accordingly, it is an object of the present invention to establish voice and data communications with ground sites on an airborne aircraft.

It is another object of the present invention to provide satellite and terrestrial voice and data communications on an aircraft via an integrated communications unit.

Yet another object of the present invention is to collect data concerning an aircraft and flight and selectively deliver the data to a ground monitoring facility.

Still another object of the present invention is to enable access to information databases and networks on the ground from an airborne aircraft.

A further object of the present invention is to utilize a Global Positioning System (GPS) to indicate aircraft location and provide updated flight progress information.

Yet another object of the present invention is to employ telephone service on an airborne aircraft via a satellite network.

Still another object of the present invention is to provide communications services on an aircraft via satellite links when the aircraft is airborne and via terrestrial cellular links when the aircraft is on the ground to reduce communications costs.

A further object of the present invention is to store aircraft and flight information collected by a processor in a remotely located non-volatile memory that is lightweight, compact and economical to protect from severe conditions relating to a downed aircraft.

The aforesaid objects may be achieved individually and/or in combination, and it is not intended that present invention be construed as requiring two or more of the objects to be combined unless expressly required by the claims attached hereto.

According to the present invention, satellite and terrestrial voice and data communications are combined into an integrated communications server system or unit that is designed preferably for installation in an aircraft. The system may alternatively be employed for a variety of remote or portable applications. The system collects and logs data concerning the aircraft and flight throughout a flight, typically via various sensors. The data may include airframe, engine, navigation, voice, video, still pictures, etc. and can be selectively delivered to a ground monitoring facility in real time via a packet data satellite link. Alternatively, the data may be cached and transmitted in bursts via a circuit or short burst message network, or transmitted in the entirety after an aircraft has landed utilizing either a terrestrial or a satellite data link. The data delivery route may be selected by on-board intelligence based on transmission path availability, cost and urgency considerations. In addition, the data may be retained by the system for manual download.

The system includes connections for aircraft crew and/or passenger computers. These connections employ either serial or Ethernet communications. The system enables access to databases on the ground for current weather and other operational data, and to electronic mail and the Internet or other networks. An external Ethernet hub or switch may be employed to permit simultaneous access by plural computers.

A Global Positioning System (GPS) receiver is included in the system for recording the aircraft location, while approximate altitude information is available using differential GPS. The GPS data (e.g., typically delivered to an aircraft owner/operator or service provider in real time via satellite) enables the owner/operator to ascertain the flight progress at will. This information may be used for fleet management and dispatch purposes, or to inform people on the ground anticipating arrival of the aircraft. When contact with an aircraft cannot be established, the prior position information may aid rescuers in locating the possibly downed aircraft.

The system includes a satellite voice terminal to facilitate voice communications and interfaces to headsets and to ordinary telephones (e.g., for use by passengers and/or crew). When the aircraft is on the ground, the system utilizes a terrestrial wireless data service, if available, to perform communications since this type of service is less expensive than satellite connections. The system typically utilizes satellite links for communications when the aircraft is airborne; however, terrestrial or airborne radio links may be employed, if available.

The system may alternatively be in the form of a portable unit. Although antennas utilized by the system are typically permanently installed on the aircraft, the system electronics may be portable, thereby eliminating the necessity for Government approvals of each installation and of permanently installed communications and navigation equipment, commonly requiring rigorous approvals. Government approved antennas may be installed under authority of a qualified technician. The portable system connects to the aircraft audio either via connections to the pilot headset (e.g., using a provided adapter) or to an external telephone interface included on some aircraft audio panels and intercoms.

The portable system may be connected to aircraft power via a cigarette lighter socket or a permanently installed outlet (e.g., professionally installed and approved by a qualified technician). An auxiliary power output can be provided for other portable equipment, such as a notebook or Personal Digital Assistant (PDA). This is particularly useful in aircraft providing 28 V, since a majority of portable devices require 12 V DC power as input to their adapters. An optional variable voltage DC output may be included for equipment lacking a 12 V adapter and requiring power other than 12 V DC.

The present invention provides several features and advantages. In particular, the system constantly reports aircraft position to interested parties on the ground. This position data aids dispatch and fleet management and may further be used to assist search and rescue efforts. Airframe and engine sensor data may be collected by the system for in flight monitoring and permanent logging. This is useful for maintenance by allowing increased service intervals and early detection and repair of problems prior to occurrence of failures during a flight. The collected data may be saved for download at the end of a flight or upon return to an aircraft maintenance base. Alternatively, the collected data may be reported in real time along with position and altitude information for certain situations, such as an emergency. The logged data may further be stored in a remote non-volatile memory that can easily be protected against severe conditions and retrieved from a downed aircraft.

The system provides telephone communications (e.g., even in remote parts of the world) and access to electronic mail and the Internet for crew and passengers. The system further provides in flight access to current weather information and may display a moving map and flight data for passengers without utilizing the aircraft navigation equipment.

The above and still further objects, features and advantages of the present invention will become apparent upon consideration of the following detailed description of specific embodiments thereof, particularly when taken in conjunction with the accompanying drawings, wherein like reference numerals in the various figures are utilized to designate like components.

### BRIEF DESCRIPTION OF THE DRAWINGS

FIG. 1 is a diagrammatic illustration of an exemplary communications system employing the aircraft communications unit of the present invention.

FIG. 2 is a block diagram of the aircraft communications unit of the present invention.

FIG. 3 is a block diagram of the aircraft communications unit processor illustrating the software architecture for controlling the unit to facilitate communications according to the present invention.

### DETAILED DESCRIPTION OF THE PREFERRED EMBODIMENTS

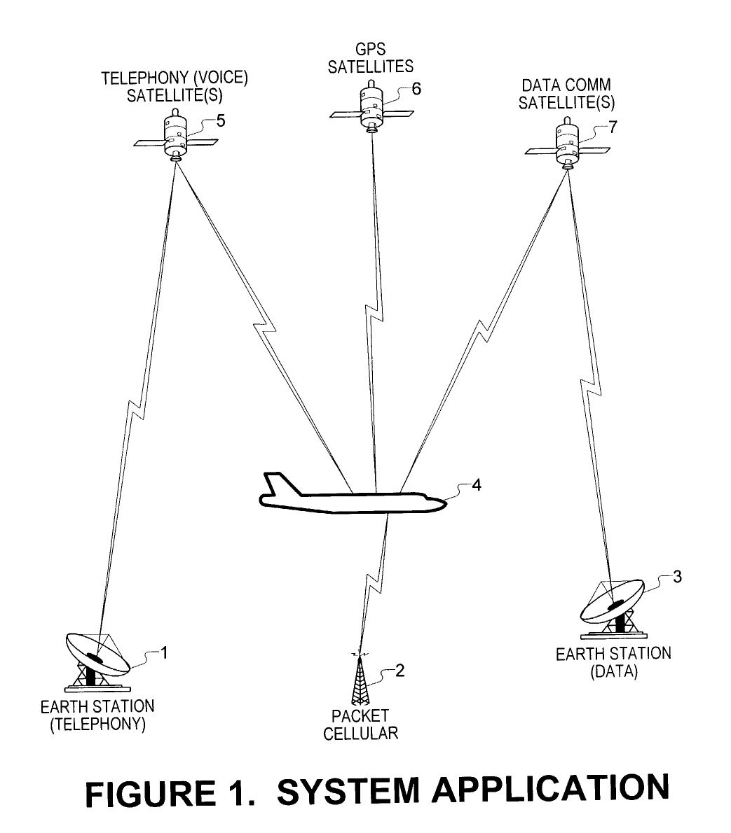

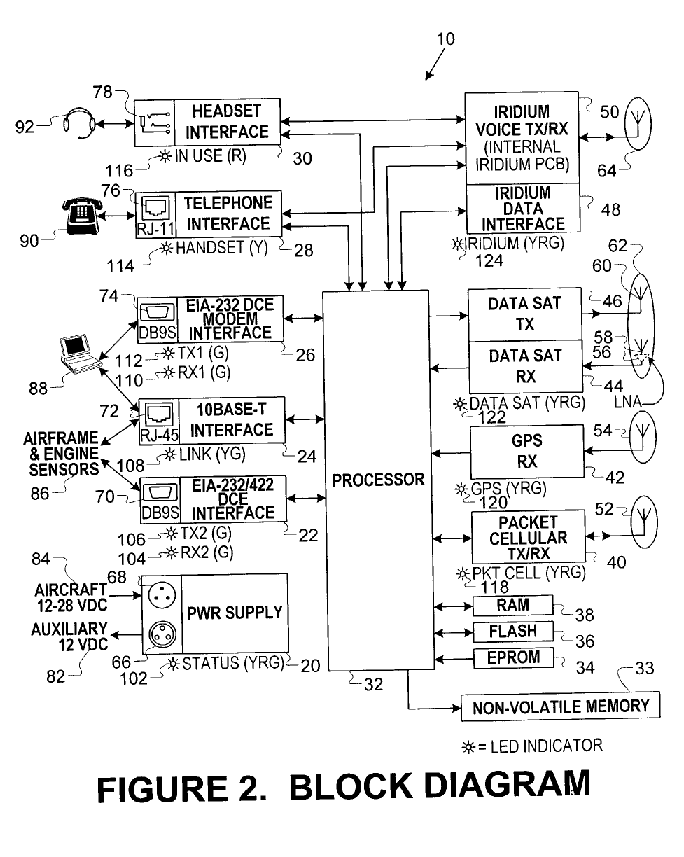

The present invention is directed toward an aircraft communications system or unit that establishes voice and data communications (e.g., telephone service, network access, etc.) between the aircraft and ground sites. The communications unit establishes the voice and data communications from an aircraft (e.g., airborne or on the ground) via satellite links, but preferably establishes these communications from the aircraft via terrestrial cellular links when the aircraft is on the ground. An exemplary communications system employing the present invention aircraft communications system or unit is illustrated in FIG. 1. Specifically, the communications system includes a voice or telephony satellite system 5 (e.g., including at least one satellite) and corresponding earth station 1, a digital packet terrestrial cellular network 2, a Global Positioning System (GPS) satellite network 6 (e.g., including at least two satellites) and a data communications satellite system 7 (e.g., including at least one satellite) and corresponding data earth station 3. Aircraft communications unit 10 (FIG. 2) of the present invention is mounted in an aircraft 4. By way of example only, the aircraft is illustrated as an airplane; however, the aircraft may be any type of aircraft (e.g., propeller, jet, light plane, airline, helicopter, etc.). The communications unit facilitates communications with terrestrial cellular network 2, telephony satellite system 5, GPS satellite network 6 and data communications satellite system 7 as described below. Communications unit 10 may utilize one or more antenna assemblies (e.g., generally less than three antenna assemblies, each of which include one or more antennas) mounted to the aircraft to receive position information from GPS satellite network 6 and facilitate the communications described above.

Telephony satellite system 5 communicates with communications unit 10 and telephony earth station 1 to transfer voice information between the communications unit and a ground site in communication with earth station 1, preferably via conventional ground telephone systems (e.g., POTS, cellular, etc.). This path is typically utilized to provide telephone service on the aircraft as described below. Data communications satellite system 7 communicates with communications unit 10 and data earth station 3 to transfer data between the communications unit and a ground site in communication with earth station 3, preferably via conventional ground communications systems (e.g., Internet or other public or private data network, POTS, cellular, etc.). This path may be utilized for transferring flight information between communications unit 10 and ground personnel as described below. The GPS satellite network basically provides communications unit 10 with aircraft location and altitude, thereby indicating flight progress. In addition, communications unit 10 may transfer large amounts of data via terrestrial cellular network 2 when the aircraft is on the ground. Since terrestrial network utilization is less expensive than the satellite networks, this enables reduction of costs. The various earth stations, networks and satellite systems are typically implemented by conventional devices, networks or systems.

Since operation of conventional cellular telephones on an airborne aircraft is a violation of FCC regulations in the United States and is a potential interference hazard, satellite voice service provides a safe and reliable alternative to cellular telephones in airborne applications, and may further enable worldwide coverage. Telephony satellite system 5 may be implemented by various types of satellite systems. For example, Low Earth Orbit (LEO) and Middle Earth Orbit (MEO) constellations are preferable due to reduced propagation delay in comparison to Geosynchronous Earth Orbit (GEO) satellites with an approximate quarter second delay. Further, the high power and directional antenna required to communicate over a longer path length for geosynchronous satellites impedes operation with hand-held voice terminals, and requires a heavy, bulky, expensive antenna on the aircraft. Accordingly, satellite system 5 is preferably implemented by the Motorola Iridium System (LEO) that provides worldwide coverage. However, any other satellite systems (e.g., GEO, LEO, MEO, etc.), circuit or packet based, may be utilized. Basically, circuit based system costs are accrued based on usage time, while packet based system costs are accrued based on the bytes or packets transferred.

Data communications satellite system 7 may be implemented by GEO, MEO or LEO satellite constellations with either a packet or circuit based interface, while data and voice functions may share a satellite RF link. Current LEO and MEO mobile satellite systems are circuit based (e.g., employing FDMA/TDMA or CDMA protocols). Systems that include packet capability are typically circuit systems that establish a circuit to transfer packets, thereby resulting in charges by the minute instead of by the byte or packet. Thus, the economic advantages of packet operation may be forfeited by these types of systems, especially for very short repetitive bursts of real time GPS position data. Some LEO, MEO and GEO systems may offer true packet capability and costs based on bytes or packets. However, the GEO systems require substantially more power (e.g., in short bursts). In addition, Short Messaging Service (SMS) offered by mobile satellite voice operators, including Iridium, may be economical for real time GPS position reports. Accordingly, data communications satellite system 7 is preferably implemented by the known Globalstar System. However, any other satellite systems may be utilized.

Terrestrial cellular network 2 may be implemented by any conventional cellular services for data communications, or other non-cellular voice or data communication services. The service should be ubiquitous, at least within North America, and preferably include worldwide coverage. A circuit based system may be utilized more readily with the terrestrial system than with the satellite systems due to lower costs of terrestrial system airtime and higher volume of data traffic concentrated over a relatively short usage period (e.g., during the interval the aircraft is on the ground prior and subsequent to a flight).

Various conventional cellular services or other wireless networks are available for use by communications unit 10 to transfer data. For example, mobile data packet services may be utilized, such as the BellSouth (Cingular) system (i.e., formerly RAM Mobile Data) or Cellular Digital Packet Data (CDPD). Coverage of these networks is typically limited to urban areas in North America, while similar services in other countries are not likely to be compatible with the BellSouth service. A dial-up connection via a circuit based cellular voice network may be employed since this type of service is widely available.

In addition, next generation packet services may be employed, such as General Packet Radio Service (GPRS, also known as 2.5 G since it is an interim bridge between second (2 G) and third generation (3 G) cellular data services) and third generation wireless broadband (3 G). 3 G is becoming available in population centers throughout the world. The various conventional services described above include geographical limits on availability and international compatibility issues. Thus, the particular service employed is based on technical and business concerns.

Although operation of cellular telephones in an airborne aircraft is a violation of regulations and a potential interference hazard as described above, these telephones may be utilized while an aircraft is on the ground. Accordingly, the terrestrial cellular network may employ various conventional services to accommodate voice data. When a cellular based terrestrial data link is available (e.g., dial-up modem, CDPD, 2.5 G or 3 G), the RF link utilized for terrestrial data may be used for voice while the aircraft is on the ground. This results in substantial savings in operating costs. The same result may be achieved by use of a conventional cellular telephone to transfer voice while the cellular terrestrial data link transfers data when the aircraft is on the ground.

The aircraft communications unit of the present invention is illustrated in FIG. 2. Specifically, the unit includes a power supply 20, a sensor serial interface 22, an Ethernet interface 24, an equipment serial interface 26, a telephone interface 28, a headset interface 30, a packet cellular transceiver 40, a GPS receiver 42, a data communications satellite receiver 44 and corresponding transmitter 46, a satellite voice terminal 50 with data interface 48 and a processor 32 to control device operation. Power supply 20 is typically implemented by a conventional switching power supply and receives aircraft DC power 84, typically 12 V DC or 28 V DC (e.g., 10 V DC minimum and 30 V DC maximum) through a conventional power connector 68. The power supply is a wide input type switching supply and protected against power spikes and surges. The power supply includes low noise circuitry with adequate shielding to avoid interference with sensitive RF circuits within communications unit 10. The power supply typically provides appropriate power signals to the communications unit components and may further provide 12 V DC via a conventional output connector 66. In addition, the power supply may optionally provide a user-selectable variable output of 5 V DC-20 V DC. The power output is selectable via a software command or other device (e.g., switch, knob, etc.) on the power supply. A multi-colored status light (e.g., yellow, red and green LED) 102 may be associated with the power supply to indicate the status of the power supply and processor 32. By way of example, the status light is illuminated red if processor 32 is inoperable, the status light is illuminated yellow during booting and initialization of the processor and the status light is illuminated green in response to proper processor operation. The status light is not illuminated when power is absent from the power supply.

Sensor interface 22 is coupled to processor 32 and is preferably implemented by a conventional EIA-232/422 DCE asynchronous serial type interface (e.g., an Electronic Industries Association (EIA) standard Data Communication Equipment (DCE) interface). Interface 22 includes a DB9 type connector 70 for coupling to airframe and engine sensors 86. Interface 22 basically couples and transfers data from these sensors to processor 32. The interface may further include colored receive and transmission status lights (e.g., green LED) 104, 106 to indicate proper flow of data to and from the interface. By way of example, receive light 104 is illuminated to indicate reception of data, while transmission light 106 is illuminated to indicate transmission of data.

Ethernet interface 24 is coupled to processor 32 and is preferably implemented by a conventional half duplex Ethernet 10Base-T type interface. Alternatively, 100Base-T and full duplex type interfaces may be employed; however, the half duplex interface is preferable as a cost effective manner to accommodate the low data rates available from wireless links. Interface 24 includes an RJ-45 Ethernet type connector 72 for coupling sensors 86 or external portable equipment 88 (e.g., computer, PDA, notebook, lap top, etc.) to processor 32. Thus, interface 24 provides an alternative path to the processor for collecting sensor data. The Ethernet interface may alternatively be coupled to an external or internal Ethernet hub or switch to facilitate connection of the communication unit with plural portable equipment 88. The Ethernet interface may further be associated with a multi-colored link status light (e.g., yellow and green bi-color LED) 108 to indicate a status of the Ethernet link. By way of example, the link status light is illuminated green to indicate a proper link, while the status light is illuminated yellow momentarily to indicate activity.

Sensors 86 may be located at any desired locations on the aircraft (e.g., frame, engines, internal systems, etc.) to measure various conditions. For example, the sensors may include a pressure altitude transducer to measure and provide altitude information in the absence of differential GPS information (described below) or to improve the accuracy of GPS derived information. This type of sensor is connected to a static reference and may be coupled to an aircraft pitot/static system. The sensor may alternatively be mounted outside of the aircraft pressurized cabin (e.g., a luggage compartment). This arrangement provides less accurate measurement, but reduces costs by avoiding connection to the pitot/static system. Further, sensors 86 may include a panic button for activation in certain situations (e.g., an emergency) to enable real time transmission of GPS position reports and other information or increase the frequency of transmission of that information. This button may further serve to facilitate accumulated airframe and engine data to be transmitted in reverse time (e.g., last in first out) order with new data interspersed and transmitted upon collection, so as to pass the maximum amount of relevant data should communications be lost in a crash.

In addition, a weight sensor (e.g., squat switch) that detects weight on the landing gear may be employed to indicate the presence of the aircraft on the ground. Alternatively, this information may be derived from GPS position data (e.g., when an airplane ceases motion this generally indicates the airplane is on the ground). Since hovering type aircraft (e.g., helicopters) may cease motion while airborne, a squat switch may be employed with these types of aircraft to indicate presence of those aircraft on the ground. The determination of aircraft presence on the ground may be utilized to switch data and/or voice communications from the satellite systems to the terrestrial cellular network to reduce costs.

The sensors are typically implemented by conventional sensing devices configured for ascertaining measurements with respect to the particular application (e.g., a conventional altitude transducer may be employed to measure aircraft altitude). The sensors may be directly connected to communications unit 10 via asynchronous serial interface 22 or Ethernet interface 24 as described above, or via a conventional Controller Area Network (CAN) or the conventional byteflight high speed data bus protocol or other protocols suitable to the task. Alternatively, the sensors may be connected to an independent data concentrator or processor (not shown) that collects and interprets sensor data and reports results to communications unit 10.

Equipment interface 26 is coupled to processor 32 and is preferably implemented by a conventional EIA-232 DCE modem type interface. This interface includes a DB9 type connector 74 for coupling to external portable equipment 88. Interface 26 appears to computers as a modem, and provides another asynchronous serial interface between external equipment 88 and processor 32. Interface 26 may further be associated with colored reception and transmission status lights (e.g., green LED) 110, 112 to indicate reception and transmission of data. By way of example, reception status light 110 is illuminated to indicate reception of data, while transmission status light 112 is illuminated to indicate transmission of data.

Telephone interface 28 is coupled to processor 32 and to satellite terminal 50 and is preferably implemented by a conventional Plain Old Telephone Service (POTS) interface. The telephone interface includes a standard RJ-11 type connector or jack 76 for coupling to telephone equipment 90 (e.g., the interface supports standard landline telephones including cordless type telephones). Telephone interface 28 may further be associated with a colored status light (e.g., yellow LED) 114 to indicate telephone equipment status. By way of example, the status light is illuminated to indicate that the telephone equipment is being utilized (off-hook).

The telephone interface couples telephone equipment 90 to satellite terminal 50 to facilitate handling of telephone calls. Accordingly, the interface provides telephone line status (e.g., on-hook, off-hook, etc.) and receives instructions from processor 32 to apply ringing voltage through jack 76 to telephone equipment 90. The processor controls the satellite terminal in accordance with the telephone line status received from interface 28. The telephone interface basically includes conventional circuitry to provide loop current to the telephone line, apply ringing voltage to ring telephone equipment 90 and terminate audio signals from the telephone line to satellite terminal 50. In addition, the circuitry receives and decodes DTMF touch tones from the telephone and transmits the information (e.g., dialed telephone number) to processor 32. The processor controls satellite terminal 50 to place a call and to disconnect the call when an on-hook condition is received from interface 28.

Headset interface 30 is coupled to processor 32 and satellite terminal 50 and is preferably implemented by a conventional headset interface. The headset interface includes a conventional headset connector or jack 78 for coupling to a headset 92. The headset enables a user to communicate within a telephone conversation without utilization of telephone equipment 90. This may be preferable for convenience purposes or in situations where the surrounding environment is noisy. Audio signals are transferred between the headset and satellite terminal 50, where the headset transmits and receives those signals at standard headset levels and impedance. The headset and/or interface may further transmit and receive signals at line level for interfacing aircraft audio panels. Headset interface 30 may include a colored status light (e.g., red LED) 116 to indicate headset status. By way of example, the status light is illuminated to indicate that the headset is being utilized in a telephone conversation (off-hook).

Satellite terminal 50 is coupled to processor 32, telephone interface 28 and headset interface 30 and is preferably implemented by a conventional Iridium satellite system transceiver to communicate with satellite system 5 (FIG. 1) to facilitate telephone call service and other communications (e.g., data transference). Iridium data interface 48 is coupled to satellite terminal 50 and processor 32 and enables transference of low speed data from processor 32 to ground stations for telemetry and other applications (e.g., voice, still pictures, etc.). Interface 48 is typically implemented by a conventional Iridium data interface. The satellite terminal may be associated with a multi-colored status light (e.g., yellow, red and green LED) 124 to indicate the satellite terminal status. By way of example, the status light is illuminated red if the Iridium signal is unavailable, the status light is illuminated green if the terminal is operating normally but not utilized, and the status light is illuminated yellow when the terminal is in use.

The satellite terminal is coupled to an external antenna 64 to communicate voice and data to satellite system 5. The antenna is preferably implemented by a dedicated single L-Band (e.g., 1.5-1.7 GHz) type antenna. The separate antenna is utilized since the terminal transmits bursts continuously during a call on the satellite system. Antenna 64 is electrically independent from a communications unit GPS antenna 54 (described below) used by GPS receiver 42. The electrical independence prevents the Iridium transmission power from overwhelming the GPS receiver. A single antenna is employed by the satellite terminal since the terminal communicates using a time division duplex protocol, thereby enabling alternate use of the receiver and transmitter (e.g., the receiver and transmitter do not operate simultaneously). However, a combined antenna assembly may be employed to enable utilization of a single antenna installation to provide antennas 54, 64. In addition, other antennas (e.g., for the packet cellular network, data communications satellite system, etc.) may be combined to reduce the quantity of antenna installations mounted on the airframe.

Data satellite receiver 44 and transmitter 46 are each connected to processor 32 and are preferably implemented by conventional transmitters and receivers for the particular data satellite system employed for data communications satellite system 7, preferably the Globalstar System. The transmitter and receiver facilitate communications with data communications satellite system 7 (FIG. 1) and are connected to a dual antenna assembly 62. The antenna assembly includes a receive antenna 58 and a transmit antenna 60, preferably within a single housing with coaxial cables. Receive antenna 58 may include a Low Noise Amplifier (LNA) 56 to boost the receive signal and allow longer antenna cable installations. Amplifier 56 may be powered by DC signals on the antenna cable. Two antennas are provided to accommodate different bands for transmission and reception operation. Preferably, these antennas are suitable for communication with the Globalstar System, where the transmit antenna is a conventional L-Band (e.g., 1.5-1.7 GHz) type antenna, while the receive antenna is a conventional antenna configured to receive frequencies on the order of 2.5 GHz.

The receiver and transmitter communicate with processor 32 to transfer data via satellite system 7. This system is typically utilized to transfer short bursts of position reports from GPS receiver 42, data from airframe and engine sensors 86 received by interfaces 22, 24, and packet data from external portable equipment 88 received by interfaces 24 or 26. The transmitter and receiver may be associated with a multi-colored status light (e.g., yellow, red and green LED) 122 to indicate the operating status of those devices. By way of example, the status light is illuminated red if a signal is unavailable, the status light is illuminated green when the devices are operating properly, but not being utilized and the status light is illuminated yellow when the devices are being utilized. Thus, communications unit 10 basically enables use of plural satellite systems from a single integrated unit with minimal antenna installations.

Alternatively, the Iridium satellite network may be employed to provide data communications via a short burst message capability, thereby obviating the need for communications unit 10 to include the data satellite receiving and transmitting devices 44, 46. This reduces costs, weight and installation complexity of the communications unit.

GPS receiver 42 is coupled to processor 32 and is preferably implemented by a conventional GPS receiver. Alternatively, the GPS receiver may be available as part of a satellite packet data terminal (e.g., data satellite receiver 44). Receiver 42 is coupled to a dedicated GPS antenna 54, and receives position information from GPS satellite constellation 6 (FIG. 1). This information is utilized to determine aircraft position (latitude and longitude) for updating and transmitting flight progress information to interested parties (e.g., crew, passengers, ground personnel, etc.) The GPS information may be utilized to determine aircraft altitude via differential GPS techniques.

GPS antenna 54 is preferably implemented by a conventional L-Band (e.g., 1.5-1.7 GHz) type antenna and may be mounted inside the aircraft near a window or external of the aircraft. Antenna 54 is typically mounted a sufficient distance (e.g., a few feet) from antennas 58, 60, 64 to minimize interference. GPS antenna 54 may also be mounted with Iridium antenna 64 in a common housing as described above. Alternatively, the GPS receiver may share an existing antenna. For example, the GPS receiver may share antenna 60 for data packet satellite communications when the packet transmitter duty cycle is sufficiently short to prevent loss of GPS synchronization (e.g., circuit based satellite links transmit a greater portion of the time and typically interfere with GPS reception, thereby being less compatible for additional utilization with the GPS receiver). In this case, a mechanism is employed to isolate GPS receiver 42 from transmit energy to prevent damage to that receiver. The GPS receiver may share an existing GPS or other L-Band type receiving antenna utilized with existing aircraft receiving equipment (e.g., a splitter is typically employed). Basically, antenna 54 may be any L-Band antenna used for data or voice reception (e.g., where no L-Band transmission occurs on that antenna).

GPS receiver 42 may include a multi-colored status light (e.g., yellow, red and green LED) 120 to indicate receiver status. By way of example, the status light is illuminated green to indicate proper operation and the presence of a sufficient quantity of satellites to reliably locate the aircraft, the status light is illuminated red to indicate a failure and the status light is illuminated yellow to indicate an insufficient quantity of satellites to locate the aircraft.

Packet cellular transceiver 40 is coupled to processor 32 and is preferably implemented by a conventional cellular transceiver compatible with the type of cellular service or network utilized (e.g., cellular network 2 of FIG. 1). The transceiver is connected to a cellular antenna 52, preferably mounted on the aircraft and implemented by a conventional antenna configured to transmit and receive signals on the 800 MHz cellular band. Thus, the transceiver generally utilizes a dedicated antenna since the signal bandwidth varies from those of the satellite systems. The transceiver establishes communications between processor 32 and ground sites (e.g., telephones, computers, etc.) via cellular network 2. This substantially reduces costs while providing a greater bit rate, since the cellular link generally has a greater data rate and is less expensive than the satellite links. The transceiver is associated with a multi-colored status light (e.g., yellow, red and green LED) 118 to indicate the cellular radio system status. By way of example, the status light is illuminated red to indicate a failure, the status light is illuminated yellow to indicate a weak signal and the status light is illuminated green to indicate proper operation. Alternatively, illumination of the status light green may indicate transceiver operation with a good signal, illumination of the status light red may indicate the transceiver is not operating or no signal and illumination of the status light yellow may indicate that the transmitter was correctly transmitting.

Processor 32 is coupled to or includes a RAM 38, a flash memory 36, a non-volatile memory 33 and an EPROM 34. The various memory devices (e.g., RAM, Flash, EPROM, non-volatile, etc.) are typically implemented by conventional components. The processor controls communications unit operation and illumination of the above-described status lights. The processor is preferably implemented by a conventional processor having the processing capabilities of at least an Intel 486 type processor, and generally includes sufficient bandwidth to service in real time the 10Base-T half duplex Ethernet connection (approximately 1 megabyte maximum) (e.g., interface 24), the wireless data link (e.g., 3 G terrestrial) operating at a maximum of 2.4 Megabits per second (Mbps) (300 Kilo Bytes maximum), two asynchronous serial ports (e.g., interfaces 22, 26) operating at a maximum baud of 38,400 (3.8 Kilo Bytes each), GPS position reports at less than 20 Bytes per second, external airframe or engine sensor inputs directly connected to the communication unit (e.g., typically of very low data rates), and low average data rate input/output (e.g., status monitoring and control of subsystems, status lights, background self-test and diagnostic routines, etc.).

EPROM 34 contains software to boot the processor from start-up, while flash memory 36 stores the software or programs executed by the processor to control system operation. The flash is generally a read/write memory and may further store boot software in a write protected area. In addition, telemetry data may be stored in the flash memory until that data is transmitted to ground recipients and reception is confirmed. RAM 38 is typically utilized as working storage for the processor software. Alternatively, and in order to reduce utilization of satellite links, the unit may store collected data in flash memory 36, RAM 38 and/or non-volatile memory 33 until the aircraft is on the ground and in range of a terrestrial cellular network. The stored data may be transmitted to ground recipients via the less expensive cellular links.

Non-volatile memory 33 is utilized to collect and log data. This memory may be disposed within the communications unit and may be implemented by a battery-backed RAM. Alternatively, memory 33 may be remotely located from communications unit 10, preferably mounted in the rear portion of the aircraft (e.g., tail). In this case, memory 33 is implemented by a true non-volatile memory device (e.g., not employing a battery back-up) and hardened to protect the logged data in the event of a crash. Thus, flight information may be recovered by protecting memory 33 and associated circuitry (e.g., to enable retrieval of data from the device). Since the memory has low mass and volume, the memory is easy to protect, less susceptible to shock and requires less insulating material to protect from fire. The logged data may alternatively be continuously or periodically transmitted to a ground site for storage, thereby enabling retrieval of the logged data in the event of a downed aircraft. This may be employed without or in combination with the non-volatile memory.

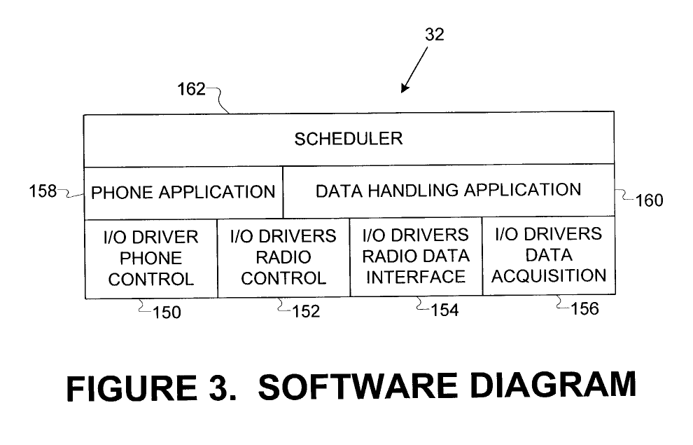

The processor controls communications unit operation under software control. The software architecture of processor 32 is illustrated in FIG. 3. Specifically, the processor includes a telephone control driver module 150, a radio control driver module 152, a radio data interface driver module 154, a data acquisition driver module 156, a telephone application module 158, a data handling application module 160 and a scheduler module 162. The software is generally protected by watchdog timeout hardware, and typically includes no conditions enabling the processor operation to be suspended (e.g., thereby requiring a restart). The software may be developed in any desired computer language. Specifically, telephone control driver module 150 includes drivers (e.g., software to control particular hardware) to control telephone interface 28 and headset interface 30 (FIG. 2), while radio control driver module 152 includes drivers to control satellite terminal 50, data satellite receiver and transmitter 44, 46, GPS receiver 42 and packet cellular transceiver 40. The telephone and radio control drivers are basically responsible for supervising the establishment and maintenance of connections and administration and control of the various satellite and cellular devices for voice and data connections.

Telephone application module 158 basically facilitates higher level telephone functions (e.g., turning dial tone on and off, accepting DTMF touch tone digits from the telephone equipment, ringing the telephone equipment, etc.). These functions are typically accomplished through telephone interface 28 via appropriate drivers within telephone control driver module 150. The telephone application module further controls satellite terminal 50, via drivers within radio control driver module 152, to establish and maintain communications for a call. The voice information that is transferred between satellite terminal 50 and telephone and headset interfaces 28, 30 is accomplished via a direct connection (e.g., the voice information does not pass through the processor). The processor is basically used for controlling the connection (e.g., setting up and placing a call, announcing a call, disconnecting a call, etc.) and is typically not involved in actually transferring voice or digital data between the satellite terminal and the telephone and headset interfaces.

Radio data interface driver module 154 includes drivers that facilitate transfer of data between the processor and packet cellular transceiver 40, data satellite receiver and transmitter 44, 46 and satellite terminal 50 (e.g., via data interface 48). This module further includes drivers to facilitate collection of information from GPS receiver 42. The drivers are generally utilized by data handling application module 160 to transfer information between the various devices as described below. Data acquisition driver module 156 includes drivers for facilitating transfer of data between the processor and the various data interfaces (e.g., serial interface 22, Ethernet interface 24, equipment interface 26, etc.). These drivers are basically utilized by data handling application module 160 to control the interfaces and transfer data between the processor and connected external equipment (e.g., sensors 86, portable equipment 88, etc.) as described below.

Voice data is typically transferred to satellite terminal 50 via direct connections between that terminal and the telephone and headset interfaces as described above. However, transference of data between the communications unit interfaces (e.g., interfaces 22, 24, 26) and satellite and terrestrial cellular links is accomplished through processor 32. In particular, the processor receives data from interfaces 22, 24, 26, cellular transceiver 40, GPS receiver 42, data satellite receiver 44 and satellite terminal 50 (e.g., through data interface 48), and basically serves as a switch to direct the data to the appropriate communications unit devices.

The processor accomplishes this switching function through data handling application module 160 that controls transference of data between the processor and communications unit devices (e.g., interfaces 22, 24, 26, cellular transceiver 40, GPS receiver 42, data satellite receiver and transmitter 44, 46 and satellite terminal 50 (via data interface 48)) via the drivers in radio and data acquisition driver modules 154, 156. Specifically, data handling application module 160 utilizes the drivers within data acquisition driver module 156 to control interfaces 22, 24, 26 and facilitate transfer of data between these interfaces and processor 32. This enables data handling module 160 to receive sensor information from sensors 86 for transference to a satellite or cellular link, and to communicate with portable equipment 88 for transference of data between that equipment and the satellite or cellular link (e.g., for accessing a ground database or network). Similarly, data handling module 160 utilizes drivers within radio driver module 154 to facilitate transfer of data between processor 32 and cellular transceiver 40, GPS receiver 42, data satellite receiver and transmitter 44, 46 and satellite terminal 50 (via data interface 48). Thus, processor 32 is coupled to the communications unit interfaces and the satellite and terrestrial cellular links, while the processor data handling module coordinates transference of data between the interfaces and links to facilitate communications with ground sites.

The telephone application and data handling application modules are under control of scheduler 162. The scheduler may be implemented by a custom or conventional real time operating system (RTOS) to control various applications and corresponding drivers. Scheduler 162 may further control conventional maintenance and miscellaneous functions for processor operation. The scheduler basically coordinates interface activity via the drivers and applications in real time so that these functions are performed on a regular schedule without data loss. The various drivers of the processor modules buffer incoming and outgoing data, while the scheduler ensures that the processor applications service the drivers periodically and on a regular basis to avoid data loss. In other words, the scheduler ensures that the applications retrieve information from the drivers prior to the buffered data being overwritten with newly collected data. The various modules of the processor are typically implemented by software performing conventional real time tasks.

The processor may include modules to process, format and display collected data. For example, the processor may include a module to process GPS data received from GPS receiver 42 to determine aircraft location. This module may further determine aircraft altitude based on differential GPS techniques. The module may further display flight progress to interested parties (e.g., crew, passengers, ground personnel, etc.) in accordance with the GPS information. The display may be in the form of a map or other graphical or textual display. Further, the processor may process the sensor information for display and/or transfer to interested parties, and may determine the appropriate satellite or terrestrial cellular links to utilize based on various conditions (e.g., costs, availability, aircraft location, amount of data to transfer, etc.). The processor may basically format any information (e.g., sensor, portable equipment, etc.) in any desired format for display and/or transference with ground sites (e.g., continuously, at any desired intervals, etc.). The above functions may be performed by any of the processor modules described above, additional modules or modules within an independent processor (e.g., on the ground and/or in the aircraft) in communication with the communications unit. In addition, the independent processor may receive raw data from the communications unit and process that data for storage and/or display. The information processed by processor 32 may be handled by data handling module 160 for transference to the appropriate communications unit devices (e.g., satellite or cellular links, interfaces, portable equipment, etc.) to enable the information to be transmitted to the intended ground (e.g., database, network, etc.) or aircraft (e.g., portable equipment, etc.) site.

The communications unit and corresponding antennas are typically installed within an aircraft in a generally permanent fashion. However, the communications unit may alternatively be in the form of a portable unit. Although antennas utilized by the communications unit are typically permanently installed on the aircraft, the communications unit electronics may be portable, thereby eliminating the necessity for Government approvals of each installation and of permanently installed communications and navigation equipment, commonly requiring rigorous approvals. The portable unit may connect to aircraft audio either via connections to the pilot headset (e.g., using a provided adapter) or to an external telephone interface included on some aircraft audio panels and intercoms.

The portable unit may be connected to aircraft power via a cigarette lighter socket or a permanently installed outlet (e.g., professionally installed and approved by a qualified technician), while an auxiliary power output may be provided as described above for other portable equipment, such as a notebook or Personal Digital Assistant (PDA). This is particularly useful in aircraft providing 28 V, since a majority of portable devices require 12 V DC power as input to their adapters. An optional variable voltage DC output may be included as described above for equipment lacking a 12 V adapter and requiring power other than 12 V DC.

Communications unit 10 should generally operate and be stored in environments including conditions where the humidity is in the range of 0% to 95% (e.g., non-condensing) and the altitude is a maximum of 50,000 feet. The temperature for operation should be in the range of −20° C. to +50° C., while the storage temperature should be in the range of −40° C. to +85° C. The various status lights are typically disposed on a communications unit housing panel for visibility to a user and are preferably implemented for portable versions of the unit since the unit is visible to a user. When the unit is for installation in an aircraft beyond the visibility of users, the unit may be employed without the status lights. For safety reasons, red status lights may not be used if visible to cockpit crew.

Operation of the unit is described with reference to FIGS. 1-2. Initially, communications unit 10 and the corresponding antennas are disposed in and/or mounted on the aircraft at any suitable locations. Non-volatile memory 33 may be mounted in the rear of the aircraft remote from communications unit 10 to store sensor and other data as described above. The power supply is connected to aircraft power as described above. When the communications unit is portable, the unit may be employed on different aircraft, where the corresponding antennas are already mounted. Processor 32 boots and enables the communications unit to perform the various communications functions described above to establish communications with ground sites. For example, the processor collects and stores aircraft sensor information from sensors 86 periodically or the information may be collected, stored in memories (e.g., memory 33, etc.) and transmitted to ground sites as described above. Users may connect portable equipment to the communications unit and access databases and/or networks on the ground via satellite links as described above. Telephone service may be provided by the communications unit via satellite links, where users may utilize handsets or headsets for a call. The communications unit receives GPS information to determine aircraft location and altitude, and thereby may provide current flight status information to interested parties (e.g., ground personnel, operator, crew, passengers, etc.). When the aircraft is on the ground, the communications unit may establish voice and data communications via terrestrial cellular network 2. In the event of a downed aircraft, memory 33 may be recovered to analyze the aircraft data.

It will be appreciated that the embodiments described above and illustrated in the drawings represent only a few of the many ways of implementing an aircraft data and voice communications system and method.

The telephony satellite system may be implemented by any type of satellite system (e.g., LEO, MEO, GEO, etc.) and may include any quantity of any type of conventional or other satellites and/or earth stations. The ground sites may be coupled to or in communication with any quantity of the earth stations via any suitable communications medium (e.g., telephone system, cellular, network, etc.).

The data communications satellite system may be implemented by any type of satellite system (e.g., LEO, MEO, GEO, etc.) and may include any quantity of any type of conventional or other satellites and/or earth stations. The ground sites may be coupled to or in communication with any quantity of the earth stations via any suitable communications medium (e.g., telephone system, cellular, network, etc.).

The unit may utilize any GPS or other satellite positioning system which may be of any type of satellite system (e.g., LEO, MEO, GEO, etc.) and include any quantity of any type of conventional or other satellites. The communications unit may receive any desired positional or other information (e.g., differential GPS, etc.) from the GPS system in any desired format. The terrestrial cellular network may be implemented by any type of cellular or other terrestrial network.

The communications unit may be disposed in any type of aircraft (e.g., jet, commercial airplane, helicopter, hovercraft, etc.), facility (e.g., space station, space shuttle, etc.), or ground or marine vehicle (e.g., any type of vehicle, vessel, craft, etc.) capable of utilizing satellite communications. The communications unit may be employed to facilitate communications between aircraft (e.g., aircraft to aircraft communications between aircraft that are airborne or on the ground) or between other vehicles and facilities and aircraft or ground installations. The various communications unit antennas may be implemented by any quantity of conventional or other antennas of any shape or size, may be constructed of any suitable materials and may be disposed at any suitable locations on or within the aircraft, vehicle or facility. The antennas may be combined in any fashion and may be configured for any desired frequencies or frequency range. The antennas may be stored in any quantity of housings for mounting on or within the aircraft, vehicle or facility.

The power supply may be implemented by any quantity of conventional or other switching, linear power supplies, and may supply any desired voltage or power signals to any communications unit components. The power supply may include any quantity of any type of conventional or other power connectors (e.g., input and/or output) that may receive and provide any desired voltage or power signals. The output connector power may be variable within any desired voltage or power range and may be selectable by a user via any suitable mechanisms (e.g., software, knob or switch on power supply, etc.).

The serial interface may be implemented by any quantity of any type of conventional or other interface for communicating with the sensors. The interface may be coupled to any quantity of any type of sensors. The interface may include any quantity of any type of conventional or other connector to interface any quantity of sensors. The sensors may include any quantity of any conventional or other sensors disposed at any locations on or within the aircraft, vehicle or facility to measure any desired characteristics (e.g., engine, frame, electronics, subsystems, etc.). The sensors may include a camera and/or audio equipment to provide audio, still pictures, video and other images of the aircraft, vehicle or facility. The sensors may further include a panic type button to facilitate immediate transmission of collected information to a ground site in certain conditions (e.g., an emergency, etc.). The button may be implemented by any quantity of any type of conventional or other switch (e.g., button, switch etc.) disposed at any suitable locations within the aircraft interior. Alternatively, the sensors may be connected to a data concentrator or independent processor to interpret the sensor data for transmission to the communications unit. The interface may transfer data in any desired format (e.g., serial, parallel, etc.).

The Ethernet interface may be implemented by any quantity of any type of conventional or other interface (e.g., 10Base-T, 100Base-T, half duplex, full duplex, etc.) for communicating with the sensors and/or portable equipment. The interface may be coupled to any quantity of any type of sensors or portable equipment (e.g., computer, PDA, notebook, etc.). The interface may include any quantity of any type of conventional or other connector to interface the sensors and/or portable equipment. The interface may be coupled to an Ethernet or other type of hub or switch to facilitate accommodation of plural portable equipment units. The interface may transfer data in any desired format (e.g., Ethernet or other protocol, etc.).

The equipment interface may be implemented by any quantity of any type of conventional or other interface for communicating with the portable equipment. The interface may be coupled to any quantity of any type of portable equipment (e.g., computer, PDA, notebook, etc.). The interface may include any quantity of any type of conventional or other connector to interface any quantity of portable equipment. The interface may transfer data in any desired format (e.g., serial, parallel, etc.).

The telephone interface may be implemented by any quantity of conventional or other telephone interfaces, and include any quantity of conventional or other circuitry, processors and/or hardware and/or software modules or units to perform the telephone interface functions described herein. The interface may be coupled to any quantity of conventional or other telephone equipment (e.g., handsets, cordless telephones, etc.). The telephone interface may include any quantity of conventional or other connectors to interface any quantity of telephone equipment.

The headset interface may be implemented by any quantity of conventional or other telephone headset interfaces. The interface may be coupled to any quantity of conventional or other telephone equipment (e.g., headsets, etc.). The headset interface may include any quantity of conventional or other connectors to interface any quantity of telephone headsets.

The satellite terminal may be implemented by any quantity of conventional or other satellite terminals compatible with the particular telephony satellite system employed. The data interface may be implemented by any quantity of conventional or other data interfaces to receive data (e.g., as opposed to voice) at the terminal. The transceiver may alternatively be implemented by any quantity of receiving and transmitting devices. The terminal antenna may be implemented by any quantity of conventional or other antennas of any shape or size, may be constructed of any suitable materials and may be configured for any desired frequency or frequency range. The antenna may be combined with other antennas or shared with other aircraft or communications unit components in any desired fashion.

The data communications receiver and transmitter may each be implemented by any quantity of conventional or other satellite receivers and transmitters compatible with the particular data communications satellite system employed. The receiver and transmitter may alternatively be implemented by a transceiver including any quantity of receiving and transmitting devices. The receive and transmit antennas may each be implemented by any quantity of conventional or other antennas of any shape or size, may be constructed of any suitable materials and may be configured for any desired frequency or frequency range. The antennas may be combined to transmit and receive data satellite signals, and/or the antennas may be combined with other antennas or shared with other aircraft, facility, vehicle, or communications unit components in any desired fashion. Alternatively, the communications unit may employ the telephony satellite system to transfer data and be implemented without the data satellite system and corresponding communications unit components (e.g., data satellite receiver, transmitter, antennas, etc.).

The GPS receiver may be implemented by any quantity of conventional or other type of receivers compatible with the particular GPS or other satellite positioning system employed. The GPS receiver may be implemented as part of other communications unit components (e.g., data satellite receiver, etc.). The GPS antenna may be implemented by any quantity of conventional or other antennas of any shape or size, may be constructed of any suitable materials and may be configured for any desired frequency or frequency range. The antenna may be combined with other antennas or shared with other aircraft, facility, vehicle or communications unit components in any desired fashion.

The cellular transceiver may be implemented by any quantity of conventional or other cellular transceivers compatible with the particular cellular or other terrestrial network employed. The transceiver may alternatively be implemented by any quantity of receiving and transmitting devices. The cellular antenna may be implemented by any quantity of conventional or other antennas of any shape or size, may be constructed of any suitable materials and may be configured for any desired frequency or frequency range. The antenna may be combined with other antennas or shared with other aircraft, facility, vehicle or communications unit components in any desired fashion.

The processor may be implemented by any conventional or other microprocessor, controller or circuitry to perform the functions described herein, while any quantity of processors or processing devices or circuitry may be employed within the communications unit, where the processor functions may be distributed in any fashion among any quantity of software and/or hardware modules or units, processors or other processing devices or circuits. The software for the communications unit processor may be implemented in any suitable computer language, and could be developed by one of ordinary skill in the computer and/or programming arts based on the functional description contained herein and the processor software architecture illustrated in the drawings. Further, any references herein of software performing various functions generally refer to processors performing those functions under software control. The software and/or algorithms described above and illustrated in the drawings may be modified in any manner that accomplishes the functions described herein. The software may be any combination of conventional and/or custom software to perform the functions described herein.

The processor may include any quantity of any type of conventional or other memory devices (e.g., flash, RAM, EPROM, non-volatile, etc.). The memories may store any quantity of any desired information. The non-volatile memory may be protected in any fashion and disposed at any suitable location on the aircraft, facility or vehicle. The processor may process collected data in any desired fashion (e.g., determine position and altitude from GPS information, flight progress, etc.) and format the data in any fashion for transference or display. The processor may format collected data in any desired format for transfer to an intended site, and may transfer data continuously, at any desired interval or in response to any desired conditions (e.g., panic button actuation, etc.). The processor may determine the link to utilize based on any desired conditions (e.g., costs, availability, aircraft location, amount of data to transfer, etc.). In addition, the processor may transmit data to a ground site in response to a signal received from that site (e.g., via a satellite or other communication system) requesting data. The processor may selectively send any quantity or type of data to any intended site formatted or arranged in any desired fashion.

The communications unit may be permanently installed within an aircraft, vehicle or facility or be portable for use on different aircraft, vehicles or facilities with antenna already mounted thereon. The communications unit may be of any quantity, shape or size, and may be disposed at any suitable locations within an aircraft, vehicle or other facility. The communications unit may include any quantity of any individual components, while the components may be arranged in any desired fashion. The communications unit may be configured to operate and be stored under any severe conditions. The status lights may be implemented by any quantity of any type of conventional or other light or visual indicator (e.g., LED). The lights may be of any desired colors to indicate any communications unit conditions. The lights may be disposed at any locations on or remote from the communications unit, and may be arranged in any fashion. The communications unit may alternatively be configured without the status lights, or include any quantity of status lights to indicate any desired conditions. The lights may be illuminated in any fashion (e.g., continuously, flashing, etc.) to indicate a condition and/or represent a particular color (e.g., simultaneous or alternate flashing of red and green may indicate yellow, etc.).

The communications unit is not limited to the applications disclosed herein, but may be utilized for any applications where satellite communications may be employed.

From the foregoing description, it will be appreciated that the invention makes available a novel aircraft data and voice communications system and method, wherein satellite and terrestrial voice and data communications are combined into an integrated communications server system or unit to establish the voice and/or data communications between aircraft (e.g., airborne or on the ground) and ground sites.

Having described preferred embodiments of a new and improved aircraft data and voice communications system and method, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A communications system for establishing voice and data communications between a platform and at least one site remote from the platform comprising:
a power supply to distribute power signals to said system;
a processor to control system operation and facilitate said communications between said platform and at least one remote site;
a data interface unit to couple platform monitoring sensors and an external processing device to said system and to transfer data between those devices and said processor;
a telephony interface to couple telephone equipment to said system and to control said telephone equipment to facilitate telephone service; and
a satellite communications unit coupled to said processor and said telephony interface to establish a communication link with at least one satellite system to receive information from that satellite system and to transfer voice and data signals between said platform and at least one remote site.

2. The system of claim 1, wherein said platform is at least one of: an aircraft, a ground vehicle, an aquatic vehicle and a facility.

3. The system of claim 2, wherein said processor includes a non-volatile memory remotely located from said processor within said platform to store at least information received from said platform monitoring sensors and at least one satellite system, wherein said non-volatile memory is protected against severe conditions to enable retrieval of said memory in the event of a crash.

4. The system of claim 1, wherein said external processing device is a computer system.

5. The system of claim 1, wherein said telephony interface includes a telephone interface to couple a telephone to said system and to control said telephone to facilitate telephone service.

6. The system of claim 5, wherein said telephony interface further includes a headset interface to couple a telephone headset to said system for use during said telephone service.

7. The system of claim 1, wherein said at least one satellite system includes a voice satellite system and said satellite communications unit includes a voice communications unit coupled to said processor and said telephony interface to establish said communication link with said voice satellite system to provide telephone service for said system and to transfer voice signals between said telephony interface and at least one remote site.

8. The system of claim 7, wherein said processor includes a telephone module to control said telephony interface and said voice communications unit to provide said telephone service.

9. The system of claim 7, wherein said voice communications unit includes a data interface to facilitate data transfer with said processor and to transfer said data between said processor and at least one remote site via said communication link.

10. The system of claim 9, wherein said voice communications unit transfers data received by said processor from said at least one satellite system and said platform monitoring sensors to at least one remote site to report platform status.

11. The system of claim 9, wherein said voice communications unit transfers data between said external processing device and at least one remote site to access information stored in a database.

12. The system of claim 9, wherein said voice communications unit transfers data between said external processing device and at least one remote site to access a network.

13. The system of claim 1, wherein said at least one satellite system includes a data communications satellite system and said satellite communications unit includes a data communications unit coupled to said processor to establish said communication link with said data communications satellite system to transfer data signals between said processor and at least one remote site.

14. The system of claim 13, wherein said data communications unit transfers data received by said processor from said at least one satellite system and said platform monitoring sensors to at least one remote site to report platform status.

15. The system of claim 13, wherein said data communications unit transfers data between said external processing device and at least one remote site to access information stored in a database.

16. The system of claim 13, wherein said data communications unit transfers data between said external processing device and at least one remote site to access a network.

17. The system of claim 1, wherein said at least one satellite system includes a Global Positioning System (GPS), and said satellite communications unit includes a GPS receiver coupled to said processor to receive platform position information from said Global Positioning System.

18. The system of claim 17, wherein said GPS receiver receives differential GPS information from said Global Positioning System, and said processor includes an altitude module to determine platform altitude from said differential GPS information.

19. The system of claim 17, wherein said processor includes a flight module to process said platform position information and determine flight progress of said platform.

20. The system of claim 1 further including a terrestrial communications unit to establish a terrestrial wireless communication link with at least one remote site for transferring voice and data signals between said platform and at least one remote site when said platform is on the ground.

21. The system of claim 20, wherein said terrestrial communications unit transfers voice signals between said platform and at least one remote site to provide telephone service.

22. The system of claim 20, wherein said terrestrial communications unit transfers data received by said processor from said at least one satellite system and said platform monitoring sensors to at least one remote site to report platform status.

23. The system of claim 20, wherein said terrestrial communications unit transfers data between said external processing device and at least one remote site to access information stored in a database.

24. The system of claim 20, wherein said terrestrial communications unit transfers data between said external processing device and at least one remote site to access a network.

25. The system of claim 20, wherein said processor includes a link module to select a communication link for communicating with at least one remote site based on particular conditions.

26. The system of claim 20, wherein said processor includes a data handling module to control transference of data between said data interface unit and said satellite and terrestrial communications units to facilitate transference of voice and data signals between said platform and at least one remote site.

27. The system of claim 1, wherein said power supply includes an output connector to provide power signals to said external processing device.

28. The system of claim 27, wherein said power supply includes a variable unit to provide power signals to said output connector in accordance with a user selected power level.

29. The system of claim 1, wherein said data interface unit includes:
a first data interface to couple said platform monitoring sensors to said system and to transfer data between those sensors and said processor;
a second data interface to couple said external processing device to said system and to transfer data between that device and said processor;
wherein said first and second interfaces are asynchronous serial interfaces.

30. The system of claim 29, wherein said data interface unit further includes a third interface to couple said platform monitoring sensors or said external processing device to said system and to transfer data between these devices and said processor.

31. The system of claim 30, wherein said third interface is an Ethernet interface.

32. The system of claim 30, wherein said third interface is coupled to a switch configured to connect a plurality of external processing devices to said system, wherein said third interface transfers data between said switch and said processor to facilitate communications between said external processing devices and at least one remote site.

33. The system of claim 1 further including at least one visual indicator to indicate a status of system operation.

34. The system of claim 1, wherein said system is configured for permanent installation within said platform.

35. The system of claim 1, wherein said system is configured to be portable for utilization within different platforms.

36. In a communications system including a data interface unit for coupling sensors and an external processing device to said system, a telephony interface for coupling telephone equipment to said system and facilitating telephone service, a satellite communications unit and a processor to control system operation, a method of establishing voice and data communications between a platform and at least one site remote from the platform comprising the step of:
(a) establishing a communication link with at least one satellite system to receive information from that satellite system and to transfer voice signals from said telephony interface and data signals from said data interface unit and said at least one satellite system between said platform and at least one remote site.

37. The method of claim 36, wherein said platform is one of: an aircraft, a ground vehicle, an aquatic vehicle and a facility.

38. The method of claim 37, wherein said processor includes a nonvolatile memory remotely located from said processor within said platform, and step
(a) further includes:
(a.1) storing at least information received from said platform monitoring sensors and at least one satellite system in said non-volatile memory, wherein said non-volatile memory is protected against severe conditions to enable retrieval of said memory in the event of a crash.

39. The method of claim 36, wherein said external processing device is a computer system.

40. The method of claim 36, wherein said at least one satellite system includes a voice satellite system and said satellite communications unit includes a voice communications unit coupled to said processor and said telephony interface, and step (a) further includes:
(a.1) establishing said communication link with said voice satellite system to provide telephone service for said system and transferring voice signals between said telephony interface and at least one remote site via said communication link.

41. The method of claim 40, wherein said voice communications unit includes a data interface to facilitate data transfer with said processor, and step (a) further includes:
(a.2) transferring said data between said processor and at least one remote site via said communication link.

42. The method of claim 41, wherein step (a.2) further includes:
(a.2.1) transferring data received by said processor from said at least one satellite system and said platform monitoring sensors to at least one remote site via said communication link to report platform status.

43. The method of claim 41, wherein step (a.2) further includes:
(a.2.1) transferring data between said external processing device and at least one remote site via said communication link to access information stored in a database.

44. The method of claim 41, wherein step (a.2) further includes:
(a.2.1) transferring data between said external processing device and at least one remote site via said communication link to access a network.

45. The method of claim 36, wherein said at least one satellite system includes a data communications satellite system and said satellite communications unit includes a data communications unit coupled to said processor, and step (a) further includes:
(a.1) establishing said communication link with said data communications satellite system to transfer data signals between said processor and at least one remote site.

46. The method of claim 45, wherein step (a.1) further includes:
(a.1.1) transferring data received by said processor from said at least one satellite system and said platform monitoring sensors to at least one remote site via said communication link to report platform status.

47. The method of claim 45, wherein step (a.1) further includes:
(a.1.1) transferring data between said external processing device and at least one remote site via said communication link to access information stored in a database.

48. The method of claim 45, wherein step (a.1) further includes:
(a.1.1) transferring data between said external processing device and at least one remote site via said communication link to access a network.

49. The method of claim 36, wherein said at least one satellite system includes a Global Positioning System (GPS), and said satellite communications unit includes a GPS receiver coupled to said processor, and step (a) further includes:
(a.1) receiving platform position information from said Global Positioning System.

50. The method of claim 49, wherein step (a.1) further includes:
(a.1.1) receiving differential GPS information from said Global Positioning System and determining platform altitude from said differential GPS information.

51. The method of claim 49, wherein step (a.1) further includes:
(a.1.1) processing said platform position information and determining flight progress of said platform.

52. The method of claim 36, wherein said communications system further includes a terrestrial communications unit, and step (a) further includes:
(a.1) establishing a terrestrial wireless communication link with at least one remote site for transferring said voice and data signals between said platform and at least one remote site when said platform is on the ground.

53. The method of claim 52, wherein step (a.1) further includes:
(a.1.1) transferring voice signals between said platform and at least one remote site via said terrestrial wireless communication link to provide telephone service.

54. The method of claim 52, wherein step (a.1) further includes:
(a.1.1) transferring data received by said processor from said at least one satellite system and said platform monitoring sensors to at least one remote site via said terrestrial wireless communication link to report platform status.

55. The method of claim 52, wherein step (a.1) further includes:
(a.1.1) transferring data between said external processing device and at least one remote site via said terrestrial wireless communication link to access information stored in a database.

56. The method of claim 52, wherein step (a.1) further includes:
(a.1.1) transferring data between said external processing device and at least one remote site via said terrestrial wireless communication link to access a network.

57. The method of claim 52, wherein step (a.1) further includes:
(a.1.1) selecting a communication link for communicating with said at least one remote site based on particular conditions.

58. The method of claim 36, wherein said data interface unit includes an interface to couple said platform monitoring sensors or said external processing device to said system, and step (a) further includes:
(a.1) transferring data signals from said interface between said platform and at least one remote site.

59. The method of claim 58, wherein said interface is coupled to a switch configured to connect a plurality of external processing devices to said system, and step (a.1) further includes:
(a.1.1) transferring data between said switch and said processor to facilitate communications between said external processing devices and at least one remote site.

60. The system of claim 2, wherein said platform is an aircraft and said at least one remote site is a ground station.

61. The system of claim 1 further including a data transmission switch, wherein actuation of said switch facilitates transfer of data received from said at least one satellite system and said platform monitoring sensors to at least one remote site in reverse time order.

62. The system of claim 1, wherein said platform monitoring sensors include an image capture device to facilitate transmission of platform images from said platform to at least one remote site.

63. The method of claim 37, wherein said platform is an aircraft and said at least one remote site is a ground station.

64. The method of claim 36, wherein said communications system further includes a data transmission switch, and step (a) further includes:
(a.1) transferring data received from said at least one satellite system and said platform monitoring sensors to at least one remote site in reverse time order in response to actuation of said switch.

65. The method of claim 36, wherein said platform monitoring sensors include an image capture device, and step (a) further includes:
(a.1) transmitting captured platform images from said platform to at least one remote site.
